(19) United States
(12) Patent Application Publication
(10) Pub. No.: US 2005/0060582 A1
(43) Pub. Date: Mar. 17, 2005

(54) Apparatus and method for providing real-time traceback connection using connection redirection technique

(76) Inventors: Yang Seo Choi, Daejeon-city (KR); Hwan Kuk Kim, Seoul (KR); Dong Il Seo, Daejeon-city (KR); Sangho Lee, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,744

(22) Filed: Dec. 30, 2003

(30) Foreign Application Priority Data
Sep. 17, 2003 (KR) 2003-64573

(51) Int. Cl. G06F 11/30

(52) U.S. Cl. 713/201; 709/224

(57) ABSTRACT

An apparatus and method for providing traceback connection using a connection redirection technique are provided. A packet blocking unit blocks an attack packet transmitted to the system and a first response packet output from the system in response to the attack packet, if a system attack sensing signal is received. A response packet generation unit generates a second response packet into which a watermark is inserted, in response to the attack packet, and transmits the second response packet to a system corresponding to the source address of the attack packet. A path traceback unit receives a detection packet containing transmission path information of the second response packet from a system existing on a transmission path of the second response packet, and based on the received detection packet, traces back the transmission path of the second response packet and identifies the location of the attacker system. According to the apparatus and method, even when an attacker attacks a predetermined system via a plurality of systems, the actual location of the attacker system can be traced back fast and accurately and damage of the victim system can be minimized.

This application claims the priority of Korean Patent Application No. 2003-64573, filed Sep. 17, 2003, the contents of which are incorporated herein by reference in their entirety.

### BACKGROUND OF THE INVENTION

1. Field of the Invention

The present invention relates to an apparatus for tracing the location of an attacker system in a network, and more particularly, to a traceback system which traces the location of an attacker system based on a real-time connection to the attacker system.

2. Description of the Related Art

A traceback connection technique is used to trace in real time the actual location of a hacker. The prior art traceback connection technique is broadly divided into an IP packet traceback technique and a TCP traceback connection technique. The IP packet traceback technique traces the actual source location of a packet whose address has been changed. The TCP traceback connection technique tracks the current location of a hacker via a plurality of intermediate systems, and is frequently referred to as a chain traceback connection technique.

The prior art traceback technique can be used only after installing traceback modules for all hosts existing on the Internet, or collecting and recording information on all packets transmitted and received on networks and connections of systems on the route used by the attacker. However, it is hardly feasible to satisfy these requirements on the Internet environment, and even though the traceback function is installed in all desired object systems, if information needed for traceback cannot be obtained from any one system among the intermediate systems visited by the attacker because of some reasons, the traceback becomes impossible.

FIG. 1 is a diagram showing an example of the prior art system attacking process.

Referring to FIG. 1, an attacker 100 belonging to a first network attacks a first victim system 110 belonging to a second network, and by using a predetermined right of the first victim system obtained through the attack, attacks a second victim system 120 of a third network, which is the final attack target.

The intermediate system (the first victim system 110) visited by the attacker can be one or more. The attacker's access to the first victim system 110 may be a normal access, not by an attack, and then, the attacker may attack the second victim system 120 that is the final target. In this case, the second victim system 120 cannot directly obtain information on the system where the actual attacker is located, and in general, in order to obtain information on the attacker, precise investigation on the first victim system 110 is needed. Accordingly, if the final victim system (the second victim system 120) cannot obtain information needed for traceback, from any one of a plurality of intermediate systems (the first victim system 110) accessed by the attacker, it is impossible to trace back to the attacker.

### SUMMARY OF THE INVENTION

The present invention provides a traceback connection system and method to minimize damage of a victim system attacked by a hacker and to trace fast and accurately the location of the attacker system.

The present invention also provides a recording medium having embodied thereon a computer program for executing a traceback connection method to minimize damage of a victim system attacked by a hacker and to trace fast and accurately the location of the attacker system.

According to an aspect of the present invention, there is provided a traceback connection apparatus comprising: a packet blocking unit, which, if a system attack sensing signal is received, blocks an attack packet transmitted to a system and a first response packet output from the system in response to the attack packet; a response packet generation unit, which generates a second response packet into which a watermark is inserted, in response to the attack packet, and transmits to a system corresponding to the source address of the attack packet; and a path traceback unit, which receives a detection packet containing transmission path information of the second response packet from a system existing on a transmission path of the second response packet, and based on the received detection packet, traces back the transmission path of the second response packet and identifies the location of the attacker system.

According to another aspect of the present invention, there is provided a traceback connection method comprising: blocking an attack packet transmitted to a system and a first response packet output from the system in response to the attack packet, if a system invasion sensing signal is received; generating a second response packet into which a watermark is inserted, in response to the attack packet, and transmitting to a system corresponding to the source address of the attack packet; and receiving a detection packet containing transmission path information of the second response packet from a system existing on a transmission path of the second response packet, and based on the received detection packet, tracing the transmission path of the second response packet and identifying the location of the attacker system.

According to the present invention, even when an attacker attacks a predetermined system via a plurality of systems, the actual location of the attacker system can be traced fast and accurately and damage to the victim system can be minimized.

### BRIEF DESCRIPTION OF THE DRAWINGS

The above objects and advantages of the present invention will become more apparent by describing in detail preferred embodiments thereof with reference to the attached drawings in which:

FIG. 1 is a diagram showing an example of the prior art system attacking process;

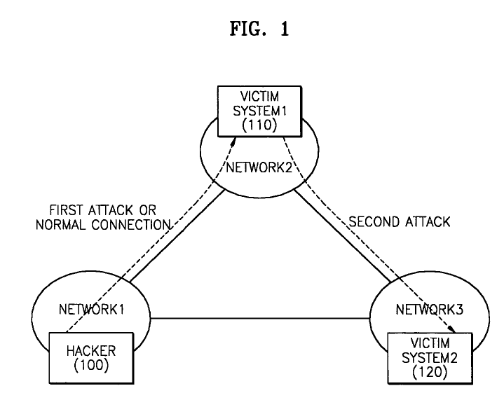

FIG. 2 is a block diagram of a structure of a traceback apparatus according to the present invention;

FIG. 3 is a schematic diagram showing a traceback process performed in the traceback apparatus, according to the present invention;

FIG. 4 is a diagram showing a traceback process for an attacker system in a network having the traceback apparatus, according to the present invention;

FIG. 5 is a flowchart of the steps performed by a traceback method according to the present invention; and

FIG. 6 is a flowchart of the steps performed by a watermark detection method in a traceback apparatus according to the present invention.

### DESCRIPTION OF THE PREFERRED EMBODIMENTS

Hereinafter, preferred embodiments of the present invention will be described in detail with reference to the attached drawings.

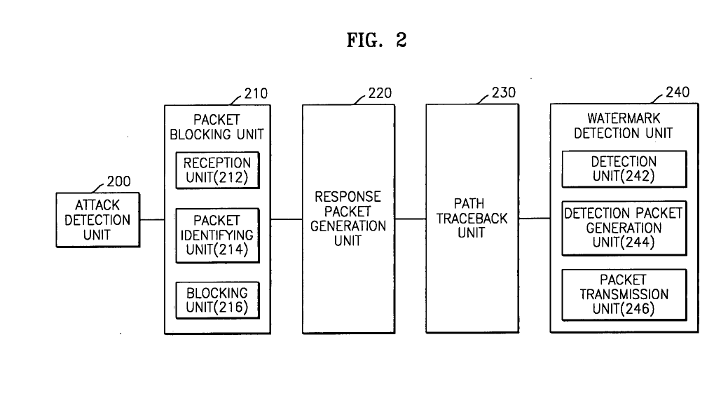

FIG. 2 is a block diagram of a structure of a traceback apparatus according to the present invention.

Referring to FIG. 2, the traceback apparatus according to the present invention comprises an attack detection unit 200, a packet blocking unit 210, a response packet generation unit 220, a path traceback unit 230, and a watermark detection unit 240. The packet blocking unit 210 comprises a reception unit 212, a packet identifying unit 214, and a blocking unit 216. The watermark detection unit 240 comprises a detection unit 242, a detection packet generation unit 244, and a packet transmission unit 246.

The attack detection unit 200 senses an attack on a victim system by an external attacker. The attack detection unit 200 may be constructed to be part of the traceback apparatus according to the present invention or implemented as a separate attack detection system. When it is implemented as a separate attack detection system, the prior art attack detection system can be used as is. The external attacker is one that attacks the victim system in order to obtain a predetermined right of the system or information by an illegal method.

If the attack detection unit 200 senses an attack against the victim system, the attack path of the victim system is identified. The source and destination IP addresses of the identified attack path and the port number are identified. The identified IP addresses and port number are included in an attack sensing signal and the signal is output. Generally, the attacker attacks a final attack object system by using an intermediate system visited prior to the attack. Accordingly, the attack path identified by the attack detection unit 200 is the path connecting the victim system and the intermediate systems. Therefore, the victim system cannot directly identify the location of the attacker system.

By investigating log files of the victim system, log files of a network connected to the victim system, and whether or not a predetermined system file of the victim system has been changed, the attack detection unit 200 can sense the system attack by the external attacker, and based on the log files of the system, identify the source IP address and port number of the attack packet.

If the attack sensing signal of the victim system from the attack detection unit 200 is received, the packet blocking unit 210 blocks the attack packet and the response packet. The attack packet is one that is transmitted by the external attacker to a victim system in order to attack the victim system, and the response packet is a response to the attack packet, which is transmitted by the attacked victim system to the external attacker. Since the attack packet of the attacker and the response packet of the attacked victim system are blocked by the packet blocking unit 210, the victim system is not damaged any more by the attacker while the traceback according to the present invention is performed.

The packet block unit 210 comprises the reception unit 212, the packet identifying unit 214, and the blocking unit 216.

The reception unit 212 receives the attack sensing signal of the victim system from the attack detection unit 200. The attack sensing signal includes the IP addresses of the source and destination of the attack path and the port number.

Based on the IP addresses of the source and destination and the port number received by the reception unit 212, the packet identifying unit 214 identifies the attack packet and the response packet, which is a response to the attack packet, among packets transmitted from and received by the victim system. For example, if the IP address of the source and destination and port number of a packet transmitted to the victim system are the same as the IP address and port number received by the reception unit 212, the packet is the attack packet. That is, based on the IP addresses, both ends of the attack path are identified, and based on the port number, the attack packet and response packet are identified among packets transmitted and received between the two ends.

The blocking unit 216 blocks the attack packet and response packet identified by the packet identifying unit 214 in the middle so that the victim system is not damaged by the attacker any more.

The response packet generation unit 220 directly generates a response packet as a response to the attack packet blocked by the packet blocking unit 210. The response packet generation unit 220 intercepts the attack packet by the attacker and generates a response packet and transmits and by doing so, performs a connection redirection function which changes the connection between the attacker system and the victim system into a connection between the attacker system and the traceback apparatus. The response packet generation unit 220 inserts a watermark, which can trace back the transmission path of the response packet, into the response packet. The response packet generation unit 220 transmits the response packet, into which the watermark is inserted, to the source IP address of the attack packet.

The response packet is finally transferred to the system of the external attacker through a variety of paths of the network. Accordingly, if the external attacker delivers an attack maintaining the connection, that is, attacks through a TCP connection, the response packet to the attack packet is transmitted to the actual location of the attacker system via multiple systems such that by using the response packet, into which predetermined path tracing data is inserted, the actual location of the attacker can be traced back.

A watermark is a bit pattern inserted into a digital image or audio or video file so that copyright information of the file can be identified. This terminology is derived from a transparent pattern (a watermark) which is faintly printed to indicate the producing company of a letter paper. Unlike the print watermark which can be seen as a faint pattern, the digital watermark cannot be seen, or when the work is audio, cannot be heard at all. Actual bits indicating a watermark are dispersed in the entire file so that they cannot be identified or manipulated. In order to see the watermark, a special program to extract the watermark data is needed.

The watermark detection unit 240 checks a packet received from the outside to detect whether or not a watermark is contained therein. If a packet containing a watermark is detected, the watermark detection unit 240 generates a detection packet containing the IP addresses of the source and destination of the packet and the port number. Then, the watermark detection unit 240 transmits the generated detection packet to a system which first inserted the watermark into the packet. The system which first inserted the watermark into the packet receives the detection packet, and based on the IP addresses and port number contained in the detection packet, traces back the path and identifies the attacker system. The watermark detection unit 240 may be installed and operated separately from other modules of the traceback apparatus.

More specifically, the watermark detection unit 240 comprises the detection unit 242, the detection packet generation unit 244, and the packet transmission unit 246.

The detection unit 242 checks a received packet to determine whether or not a watermark is contained therein. The detection unit 242 uses a special program to detect and extract a watermark.

If the detection unit 242 detects a packet containing a watermark, the detection packet generation unit 244 generates a detection packet containing the IP addresses of the source and destination and port number of the packet. In addition, the detection packet may further contain information for tracking a path.

The packet transmission unit 246 transmits the detection packet generated by the detection packet generation unit 244 to a system which first inserted the watermark into the packet. Information on the system which first inserted the watermark into the packet is included in the packet.

The path traceback unit 230 receives a detection packet from another traceback apparatus installed in the network, in response to the response packet generated and transmitted by the response packet generation unit 220. Based on the IP addresses and port number included in the detection packet, the path traceback unit 230 traces back the actual location of the attacker system. For example, if the path traceback unit 230 receives a first detection packet having the IP addresses of the source and destination of addr1 and addr2, and a second detection packet having the IP addresses of the source and destination of addr2 and addr3, the path traceback unit 230 sequentially traces the IP addresses, addr1, addr2, and addr3, such that the final location receiving the response packet can be traced back.

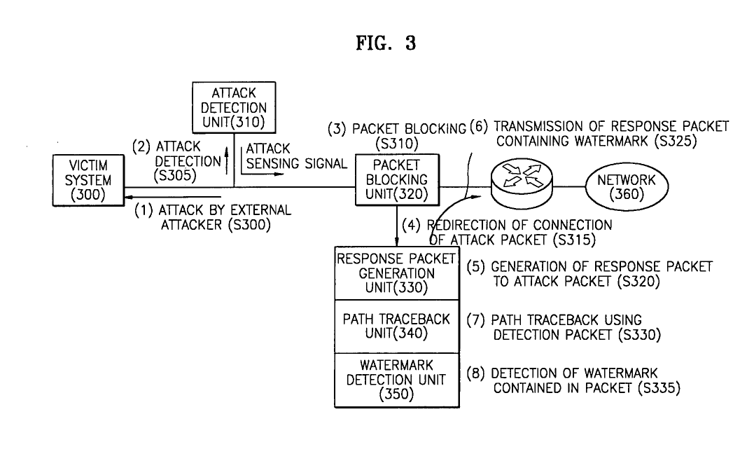

FIG. 3 is a schematic diagram showing a traceback process according to the present invention, performed in the traceback apparatus according to the present invention.

Referring to FIG. 3, a traceback apparatus is installed between the networks of a victim system 300 and an external attacker. The traceback apparatus comprises an attack detection unit 310, a packet blocking unit 320, a response packet generation unit 330, a path traceback unit 340, and a watermark detection unit 350.

The structures and functions of the attack detection unit 310, the packet blocking unit 320, the response packet generation unit 330, the path traceback unit 340, and the watermark detection unit 350 are the same as explained with reference to FIG. 2 and detailed explanations thereof will be omitted. Here, the overall flow of a traceback connection method will now be mainly explained.

If an attack to the victim system by the external attacker is delivered in step S300, the attack detection unit 310 senses the attack to the victim system in step S305. If an attack sensing signal from the attack detection unit 310 is received, the packet blocking unit 320 blocks the attack packet and the response packet in step S310 and transmits the received attack packet to the response packet generation unit 330 in step S315. Thus, the external attacker recognizes that the connection to the attack is continuously maintained and the traceback apparatus traces back the system location of the external attacker through the connection continuously maintained.

If the connection of the attack packet is redirected by the packet blocking unit 320 and the attack packet is transmitted to the response packet generation unit 330 in step S315, the response packet generation unit 330 generates a response packet into which a watermark is inserted, as a response to the attack packet in step S320. The generated response packet is transmitted finally to the attacker system via a plurality of systems on the network in step S325.

Based on the detection packet transmitted by the external system sensing the response packet, the path traceback unit 340 traces back the path of the response packet such that the location of the attacker system is identified in step S330. If the received packet contains a watermark, the watermark detection unit 350 generates a detection packet and transmits to a system which first inserted the watermark into the received packet.

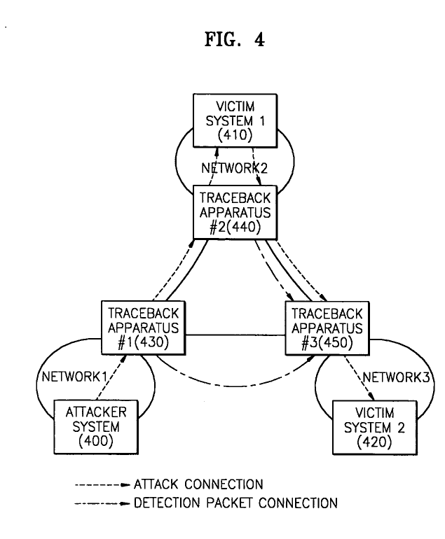

FIG. 4 is a diagram showing a traceback process for an attacker system in a network having the traceback apparatus according to the present invention.

Referring to FIG. 4, the network includes a first network to which an attacker system 400 belongs, a second network to which a first victim system 410 belongs, and a third network to which a second victim system 420 belongs. Each network has a traceback apparatus 430, 440, and 450 according to the present invention.

The attacker finally attacks the second victim system 420 of the third network via the first victim system 410 of the second network. The attacker may attack and access the first victim system 410 or access the first victim system 410 in a normal manner.

If the second victim system 420 is attacked by the attacker, the third traceback apparatus 450 blocks the response packet output form the second victim system 420, and generates and transmits its own response packet containing a watermark. The response packet containing the watermark is transferred to the attacker system via the first victim system 410.

The second traceback apparatus 440 which receives the response packet containing the watermark generates a detection packet containing the IP addresses and port number of the response packet and transmits this packet to the third traceback apparatus 450.

The response packet containing the watermark is transmitted to the first traceback apparatus 430 via the second traceback apparatus 440. The first traceback apparatus 430 which receives the response packet containing the watermark generates a detection packet and transmits the generated detection packet to the third traceback apparatus 450.

The third traceback apparatus 450 receives detection packets containing IP addresses and port number of the packet from the first traceback apparatus 440 and the second traceback apparatus 430. By tracing back the transmission path of the response packet based on the IP addresses and port number of the two received detection packets, the third traceback apparatus 450 can identify the IP address of a system finally receiving the response packet. Thus, the location of the attacker system can be traced back.

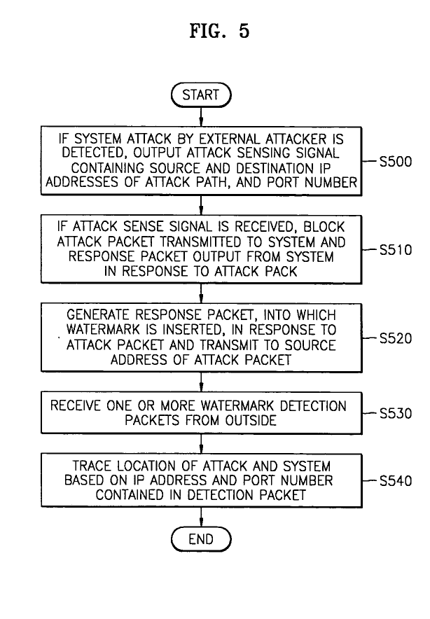

FIG. 5 is a flowchart of a traceback method according to the present invention.

Referring to FIG. 5, the attack detection unit 200 senses an attack on a system by an external attacker, and outputs an attack sensing signal containing the IP addresses of the source and destination and port number of the attack path in step S500. The attack detection unit 200 can use the prior art attack sensing system and may be implemented separately or as part of a traceback apparatus according to the present invention.

If the attack sensing signal is received, the packet blocking unit 210 blocks the attack packet transmitted to the system and the response packet output from the system as a response to the attack packet in step S510. The attack packet and the response packet are identified based on the IP addresses and port number of the attack path.

In response to the attack, the response packet generation unit 220 generates a response packet into which a watermark is inserted and transmits the response packet to the attacker system in step S520. In general, the response packet, into which the watermark is inserted, is transmitted to the attacker system via a plurality of systems.

The path traceback unit 230 receives one or more watermark detection packets from external systems in step S530 and based on the IP addresses and port number contained in the received detection packets, traces back the transmission packet of the response packet such that the actual location of the attacker system is identified in step S540.

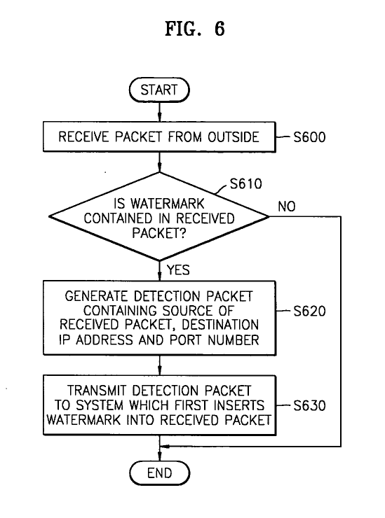

FIG. 6 is a flowchart of a method for detecting a response packet containing a watermark in a traceback system according to the present invention.

Referring to FIG. 6, the traceback system receives a packet from an external system in step S600. The watermark detection unit 240 contains a special program to detect and extract a watermark contained in the received packet, in step S610.

If the packet contains a watermark, the watermark detection unit 240 generates a detection packet containing the IP addresses of the source and destination and port number of the received packet in step S620. The watermark detection unit 240 transmits the generated detection packet to a system that first inserted the watermark to the packet in step S630.

If detection packets from the systems of the network are received, the system that first inserted the watermark traces back the path based on the IP addresses and port number contained in the detection packets and identifies the location of the attacker system.

The present invention may be embodied in a code, which can be read by a computer, on a computer readable recording medium. The computer readable recording medium includes all kinds of recording apparatuses on which computer readable data are stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be distributed to computer systems connected through a network and can be stored and executed in a distributed mode.

The present invention is not limited to the preferred embodiments described above, and it is apparent that variations and modifications by those skilled in the art can be effected within the spirit and scope of the present invention defined in the appended claims. For example, the shape and structure of each element specifically shown in the embodiments of the present invention can be modified.

According to the present invention, even when an attacker attacks a predetermined system via a plurality of systems, the actual location of the attacker system can be traced back fast and accurately. Since the attack packet and response packet are blocked if an attack against a predetermined system by an attacker is sensed, damage of the victim system can be minimized while the location of the attacker can be traced.

If needed information is not obtained from any one of multiple intermediate systems visited by the attacker, the prior art traceback system cannot trace the attacker system. However, even in such cases, the traceback system according to the present invention can trace the location of the attacker system.

1. A traceback connection apparatus comprising:
a packet blocking unit, which if a system attack sensing signal is received, blocks an attack packet transmitted to a system and a first response packet output from the system in response to the attack packet;
a response packet generation unit, which generates a second response packet into which a watermark is inserted, in response to the attack packet, and transmits the second response packet to a system corresponding to the source address of the attack packet; and
a path traceback unit, which receives a detection packet containing transmission path information of the second response packet from a system existing on a transmission path of the second response packet, and based on the received detection packet, traces back the transmission path of the second response packet and identifies the location of the attacker system.

2. The apparatus of claim 1, further comprising:
an attack detection unit, which if a system attack by an external attacker is sensed, outputs an attack sensing signal containing the IP addresses of the source and destination of the attack path and the port number.

3. The apparatus of claim 2, wherein the attack detection unit senses a system attack by the external attacker by investigating log files of the system, log files of a network, and whether or not a predetermined system file has been changed, and based on the log file of the system, identifies the IP address of the source and port number of the attack packet.

4. The apparatus of claim 2, wherein the packet blocking unit comprises:
a signal reception unit, which receives the attack sensing signal;
a packet identifying unit, which identifies the attack packet and the first response packet based on the IP addresses and the port number; and
a blocking unit, which blocks the attack packet and the first response packet.

5. The apparatus of claim 1, further comprising:
a watermark detection unit, which if a packet containing a watermark from an external network is received, transmits a detection packet containing the path information of the received packet to a system of the external network which inserted the watermark.

6. The apparatus of claim 5, wherein the watermark detection unit comprises:
a detection unit, which detects a watermark contained in a packet received from the outside;
a detection packet generation unit, which if a watermark is detected, generates a detection packet containing the IP addresses of the source and destination and port number of the received packet; and
a packet transmission unit, which transmits the generated detection packet to a system that first inserted the watermark to the packet.

7. The apparatus of claim 1, wherein the path traceback unit traces back the location of an attacker system based on the IP addresses of the source and destination and port number contained in the one or more received detection packets.

8. A traceback connection method comprising:
blocking an attack packet transmitted to the system and a first response packet output from a system in response to the attack packet, if a system invasion sensing signal is received;
generating a second response packet into which a watermark is inserted, in response to the attack packet, and transmitting the second response packet to a system corresponding to the source address of the attack packet; and
receiving a detection packet containing transmission path information of the second response packet from a system existing on a transmission path of the second response packet, and based on the received detection packet, tracing back the transmission path of the second response packet and identifying the location of the attacker system.

9. The method of claim 8, further comprising:
outputting an attack sensing signal containing the IP addresses of the source and destination of the attack path and the port number before the blocking, if a system attack by an external attacker is sensed.

10. The method of claim 9, wherein the blocking comprises:
receiving the attack sensing signal;
identifying the attack packet and the first response packet based on the IP addresses and the port number; and
blocking the attack packet and the first response packet.

11. The method of claim 8, further comprising:
transmitting a predetermined detection packet to a system of the external network which inserted the watermark, if a packet containing a watermark from an external network is received.

12. The method of claim 11, wherein transmitting a detection packet comprises:
detecting a watermark contained in a receive packet;
if the watermark is detected, generating a detection packet containing the IP addresses of the source and destination and port number of the received packet; and
transmitting the generated detection packet to a system that first inserted the watermark to the packet.

13. The method of claim 8, wherein the tracking back the transmission path comprises:
tracking back the location of an attacker system based on the IP addresses of the source and destination and port number contained in the one or more received detection packets.

14. A computer readable medium having embodied thereon a computer program for executing a traceback connection method comprising:
blocking an attack packet transmitted to the system and a first response packet output from the system as a response to the attack packet, if a system invasion sensing signal is received;
generating a second response packet into which a watermark is inserted, in response to the attack packet, and transmitting the second response packet to a system corresponding to the source address of the attack packet; and
receiving a detection packet containing transmission path information of the second response packet from a system existing on a transmission path of the second response packet, and based on the received detection packet, tracing back the transmission path of the second response packet and identifying the location of the attacker system.
